(19) United States
(12) Patent Application Publication
(10) Pub. No.: US 2026/0149135 A1
(43) Pub. Date: May 28, 2026

(54) CASE FOR SECONDARY BATTERY, SECONDARY BATTERY INCLUDING CASE, AND METHOD FOR MANUFACTURING SECONDARY BATTERY

(71) Applicant: SAMSUNG SDI CO., LTD., Yongin-si (KR)

(72) Inventor: Dae Kyu KIM, Yongin-si (KR)

(21) Appl. No.: 19/281,950

(22) Filed: Jul. 28, 2025

(30) Foreign Application Priority Data
Nov. 27, 2024 (KR) 10-2024-0172132

(51) Int. Cl. H01M 50/536; H01M 50/107; H01M 50/152; H01M 50/169

(52) U.S. Cl. CPC H01M 50/536; H01M 50/107; H01M 50/152; H01M 50/169

(57) ABSTRACT

The present disclosure provides a case for a secondary battery, a secondary battery including the case, and a method for manufacturing the secondary battery. A secondary battery may include an electrode assembly including a first electrode, a second electrode, and a separator positioned between the first electrode and the second electrode, a case accommodating the electrode assembly, the case including a bottom part and a side part, a cap assembly electrically coupled to the electrode assembly, the cap assembly sealing the case, and a first electrode tab coupled to the first electrode. The bottom part may include a first region. The first region may be coupled with the first electrode tab. The first region may include a plurality of grooves.

### CROSS-REFERENCE TO RELATED APPLICATION

The present application claims priority to and the benefit under 35 U.S.C § 119(a)-(d) of Korean Application No. 10-2024-0172132, filed in the Korean Intellectual Property Office on November 27, 2024, the entire disclosure of which is incorporated herein by reference.

### BACKGROUND

### FIELD

The present disclosure relates to a case for a secondary battery, a secondary battery including the case, and a method for manufacturing the secondary battery.

### DESCRIPTION OF THE RELATED ART

While primary batteries are not designed to be (re)charged, secondary (also known as rechargeable) batteries are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

An electrode tab included in such a secondary battery may be welded to a case. However, it is difficult to maintain a satisfactory welding strength between the electrode tab and the case. Not meeting the satisfactory welding strength, the electrode tab may be separated from the case or a contact failure between the electrode tab and the case may occur, thus degrading the performance of the battery and causing various safety issues.

Research on miniaturization and capacity enlargement of the secondary battery has been actively conducted, pursuant to the need for a more lightweight and highly functional electronic apparatuses using the secondary battery. While the capacity of the secondary battery may increase as the volume of the secondary battery increases, the secondary battery may no longer be compatible for applications incorporating the secondary battery to a relatively small device. Accordingly, there is a need for increasing the capacity of the secondary battery while maintaining or reducing the volume of the secondary battery.

The information disclosed in this Background section is for enhancement of understanding of the background of the present disclosure. The section may contain information that does not constitute related (or prior) art.

### SUMMARY

Aspects of embodiments of the present disclosure provide a case for a secondary battery, a secondary battery including the case, and a method for manufacturing the secondary battery.

According to some embodiments of the present disclosure, A secondary battery includes an electrode assembly including a first electrode, a second electrode, and a separator disposed between the first electrode and the second electrode, a case for accommodating the electrode assembly and including a bottom part and a side part, a cap assembly electrically coupled to the electrode assembly and sealing the case and a first electrode tab coupled to the first electrode. The bottom part includes a first region with which the first electrode tab is coupled. In addition, a plurality of grooves are formed in the first region of the bottom part.

Embodiments of the present disclosure provide a secondary batter including: an electrode assembly including a first electrode, a second electrode, and a separator positioned between the first electrode and the second electrode; a case accommodating the electrode assembly, the case including a bottom part and a side part; a cap assembly electrically coupled to the electrode assembly, the cap assembly sealing the case; and a first electrode tab coupled to the first electrode, wherein the bottom part includes a first region, wherein the first region is coupled with the first electrode tab, and wherein the first region includes a plurality of grooves.

According to some embodiments of the present disclosure, the electrode assembly may be formed such that the first electrode, the second electrode, and the separator may be wound on the basis of a winding axis, the first electrode may be coupled to the first electrode tab which extends in a first direction on the winding axis and is bent, and the second electrode may be coupled to the second electrode tab which extends in a second direction opposite to the first direction and is bent.

In some embodiments, the first electrode, the second electrode, and the separator are wound relative to a winding axis, wherein the first electrode is coupled to the first electrode tab which extends in a first direction relative to the winding axis and is bent, wherein the secondary battery further includes a second electrode tab, and wherein the second electrode is coupled to the second electrode tab which extends in a second direction opposite to the first direction and is bent

According to some embodiments of the present disclosure, the first electrode tab may include a trace formed by coupling the first electrode with the first region of the bottom part by welding.

In some embodiments, the first electrode tab includes a weld trace coupling the first electrode and the first region.

According to some embodiments of the present disclosure, the first region may be formed in a center of the bottom part.

In some embodiments, the first region is substantially positioned in a center of the bottom part.

According to some embodiments of the present disclosure, a shape of the first region may be any one of a circular shape, a quadrangular shape, and a hexagonal shape.

In some embodiments, the first region has a circular shape, a quadrangular shape, or a hexagonal shape.

According to some embodiments of the present disclosure, each of the plurality of grooves may have a circular shape.

According to some embodiments of the present disclosure, the plurality of grooves may have a plurality of bar shapes parallel with each other.

In some embodiments, the plurality of grooves has a plurality of bar shapes parallel with one another.

According to some embodiments of the present disclosure, the plurality of grooves may have a matrix form in which a plurality of bars are vertically intersected.

In some embodiments, the plurality of grooves has a matrix form in which a plurality of bars are perpendicularly intersected.

According to some embodiments of the present disclosure, the first electrode tab may include a second region which faces and is coupled with the first region of the bottom part, and the second region may include an embossing formed by pressing the first electrode tab in a thickness direction.

In some embodiments, the first electrode tab includes a second region facing and being coupled with the first region, and wherein the second region includes an embossing in a thickness direction of the first electrode tab.

According to some embodiments of the present disclosure, a shape of the second region may correspond to a shape of the first region.

In some embodiments, the second region has a shape corresponding to that of the first region.

According to some embodiments of the present disclosure, a maximum depth of the plurality of grooves from one surface of the bottom part may be 30 % or less of a thickness of the bottom part.

In some embodiments, the plurality of grooves has a depth equal to or less than 30 % a thickness of the bottom part.

According to some embodiments of the present disclosure, A case for a secondary battery which includes an electrode assembly including a first electrode, a second electrode, and a separator disposed therebetween, a case for accommodating the electrode assembly, a cap assembly electrically coupled to the electrode assembly and sealing the case, and a first electrode tab coupled to the first electrode, the case includes a bottom part including a first region with which the first electrode tab is coupled and a side part. A plurality of grooves are formed in the first region of the bottom part.

Embodiments of the present disclosure provide a case for a secondary battery including an electrode assembly, the electrode assembly including a first electrode, a second electrode, and a separator positioned between the first electrode and the second electrode; a cap assembly electrically coupled to the electrode assembly, the cap assembly sealing the case; and a first electrode tab coupled to the first electrode, the case including: a bottom part including a first region, the first region being coupled with the first electrode tab; and a side part, wherein the first region includes a plurality of grooves, and wherein the case accommodates the electrode assembly.

According to some embodiments of the present disclosure, a shape of the first region may be any one of a circular shape, a quadrangular shape, and a hexagonal shape.

In some embodiments, the first region has a circular shape, a quadrangular shape, or a hexagonal shape.

According to some embodiments of the present disclosure, each of the plurality of grooves may have a circular shape.

According to some embodiments of the present disclosure, the plurality of grooves may have a plurality of bar shapes parallel with each other.

In some embodiments, the plurality of grooves has a plurality of bar shapes parallel with one another.

According to some embodiments of the present disclosure, the plurality of grooves may have a matrix form in which a plurality of bars are vertically intersected.

In some embodiments, the plurality of grooves has a matrix form in which a plurality of bars are perpendicularly intersected.

According to some embodiments of the present disclosure, a method for manufacturing a secondary battery includes preparing an electrode assembly including a first electrode, a second electrode, and a separator disposed therebetween and a case including a bottom part and a side part, inserting the electrode assembly into the case, injecting an electrolyte into the case and coupling the case and the cap assembly to seal the case. The bottom part includes a first region with which a first electrode tab coupled to the first electrode is coupled, and a plurality of grooves are formed in the first region of the bottom part.

Embodiments of the present disclosure provide a method for manufacturing a secondary battery including: preparing an electrode assembly including a first electrode, a second electrode, and a separator positioned between the first electrode and the second electrode, and a case including a bottom part and a side part; accommodating the electrode assembly into the case; introducing an electrolyte into the case; and sealing the case by coupling the case and a cap assembly, wherein the bottom part includes a first region, wherein the first region is coupled with a first electrode tab, wherein the first electrode tab is coupled to the first electrode, and wherein the first region includes a plurality of grooves.

According to some embodiments of the present disclosure, the electrode assembly may be formed such that the first electrode, the second electrode, and the separator may be wound on the basis of a winding axis, the first electrode may be coupled to the first electrode tab which extends in a first direction on the winding axis and is bent, and the second electrode may be coupled to a second electrode tab which extends in a second direction opposite to the first direction and is bent.

In some embodiments, the first electrode, the second electrode, and the separator are wound relative to a winding axis, wherein the first electrode is coupled to the first electrode tab which extends in a first direction relative to the winding axis and is bent, and wherein the second electrode is coupled to a second electrode tab which extends in a second direction opposite to the first direction and is bent.

According to some embodiments of the present disclosure, the inserting of the electrode assembly into the case includes coupling the first electrode tab with the first region of the bottom part by welding and coupling the second electrode tab with the cap assembly by welding.

In some embodiments, the accommodating includes: welding the first electrode tab and the first region; and welding the second electrode tab and the cap assembly.

According to some embodiments of the present disclosure, the first electrode tab may include a trace formed by coupling the first electrode tab with the first region of the bottom part by welding.

In some embodiments, the first electrode tab includes a weld trace.

According to various embodiments of the present disclosure, a bottom part of a case may include a plurality of grooves. In this manner, the welding strength between the bottom part and a first electrode tab may be reinforced and simultaneously the certain welding strength may be ensured.

According to various embodiments of the present disclosure, a maximum depth of the plurality of grooves may be 30 % or less of a thickness of the bottom part. In this manner, reduction in the welding strength between the bottom part and the first electrode tab may be prevented even when the plurality of grooves are formed.

According to various embodiments of the present disclosure, an embossing in which the first electrode tab is pressed in a thickness direction thereof may be formed in the first electrode tab. In this manner, a plurality of protrusions constituting the embossing may correspond to the plurality of grooves in the bottom part, and thus a contact area between the bottom part and the first electrode tab may be maximized.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 shows a secondary battery according to embodiments of the present disclosure.

FIG. 2 is a cross-sectional view showing the secondary battery in a given directionaccording to embodiments of the present disclosure.

FIG. 3 is an enlarged view showing a portion of the secondary battery in FIG. 2.

FIG. 4 shows a first region according to embodiments of the present disclosure.

FIG. 5 shows a first region according to embodiments of the present disclosure.

FIG. 6 shows a first region according to embodiments of the present disclosure.

FIG. 7 shows a first region according to embodiments of the present disclosure.

FIG. 8 shows a first region according to embodiments of the present disclosure.

FIG. 9 shows a first region according to embodiments of the present disclosure.

FIG. 10 shows a first electrode tab according to embodiments of the present disclosure.

FIG. 11 shows a second region according to embodiments of the present disclosure.

FIG. 12 shows a method for manufacturing a secondary battery according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way. Therefore, the embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

Also, it will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

The embodiments described herein can be explained with reference to cross-sectional views and/or plain views as example views of the present disclosure. In the drawing, the thicknesses of films and regions can be exaggerated for effective description of technical contents. Thus, regions presented as an example in the drawings have general properties, and shapes of the exemplified areas can be used to illustrate a specific shape of a device region. Therefore, this should not be construed as limited to the scope of the present disclosure. Although the terms such as first, second, and third are used to describe various components in various embodiments herein, the components should not be limited to these terms. These terms are used only to distinguish one component from another component. Embodiments described and exemplified herein include complementary embodiments thereof. Like reference numerals refer to like elements throughout the specification.

As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components". It will also be understood that when an element is referred to as being “electrically coupled” to another element, it may be directly coupled to the other element or intervening elements may be present.

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

The terminology used herein is for the purpose of describing embodiments of the present disclosure and is not intended to be limiting of the present disclosure.

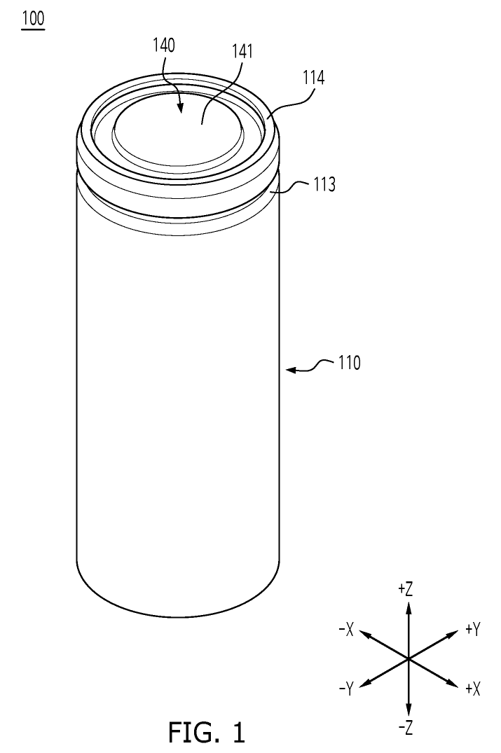

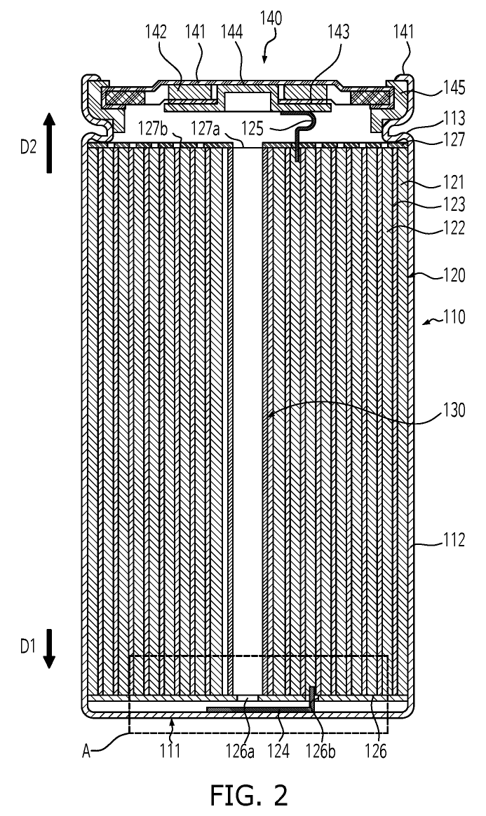

FIG. 1 shows a secondary battery 100 according to embodiments of the present disclosure.FIG. 2 is a cross-sectional view showing the secondary battery 100 in a given direction according to embodiments of the present disclosure.In FIG. 2, the cross-section of the secondary battery 100 in a given direction may refer to a cross-section in a +Y-direction and a –Y-direction or a cross-section in a +X-direction and a –X-direction as shown in FIG. 1.

As shown in FIGS. 1 and 2, the cylindrical secondary battery 100 may include a case 110, an electrode assembly 120, and a cap assembly 140. In some embodiments, the second battery 100 may further include a center pin 130.

The case 110 may include a bottom part 111 having a substantially circular shape and a cylindrical side part 112 upwardly to a certain length from a circumference of the bottom part 111. An upper part of the case 110 may be opened during a manufacturing process of the secondary battery 100. Accordingly, the electrode assembly 120 and/or the center pin 130 may be inserted into the case 110 together with an electrolyte during an assembly process of the secondary battery 100. In some embodiments, the case 110 may include steel, stainless steel, aluminum, an aluminum alloy, or an equivalent thereof, but the present disclosure is not limited thereto.

In some embodiments, to prevent the cap assembly 140 from being detached, the case 110 may include, on the basis of the cap assembly 140, a beading part 113 which is dented radially inwardly on a lower side of the cap assembly 140, and a crimping part 141 which is bent radially inwardly on an upper side of the cap assembly 140.

The electrode assembly 120 may be accommodated in an interior of the case 110. The electrode assembly 120 may include a first electrode 121 in which a negative electrode active material (for example, including graphite, carbon, or the like) is coated on a negative electrode current collecting plate, a second electrode 122 in which a positive electrode active material (for example, including a transition metal oxide such as LiCoO₂, LiNiO₂, LiMn₂O₄, or the like) is coated on a positive electrode current collecting plate, and a separator 123 which is positioned between the first electrode 121 and the second electrode 122 to prevent short circuits from happening therebetween and allow only lithium ions to migrate therebetween. The first electrode 121 may serve as a negative electrode, and the second electrode 122 may serve as a positive electrode. The electrode assembly 120 may be formed in such a manner that the first electrode 121, the second electrode 122, and the separator 123 may be wound substantially in a jelly-roll form relative to a winding axis. In some embodiments, the negative electrode current collecting plate may include a copper (Cu) foil, the positive electrode current collecting plate may include an aluminum (Al) foil, and the separator may include polyethylene (PE) or polypropylene (PP).

Referring to FIG. 2, a first electrode tab 124 of the first electrode 121 may be positioned on one side of the electrode assembly 120. A second electrode tab 125 of the second electrode 122 may be positioned on the other side of the electrode assembly 120. However, the present disclosure is not limited thereto. In some embodiments, the first electrode tab 124 and the second electrode tab 125 may be positioned on one side of the electrode assembly 120.

The first electrode tab 124, which protrudes downwardly extending to a certain length, may be coupled, for example, welded, to the first electrode 121 and the second electrode tab 125, which protrudes upwardly extending to a certain length, may be coupled, for example, welded, to the second electrode 122, and vice versa. In some embodiments, the first electrode tab 124 may include copper (Cu) or nickel (Ni), and the second electrode tab 125 may include aluminum (Al), but the present disclosure is not limited thereto.

The first electrode 121 may be coupled to the first electrode tab 124, which extends in a first direction (for example, the D1 direction) on the winding axis and is bent. In some embodiments, the first electrode tab 124 may include a plane which is vertically bent and parallel with the bottom part 111. The second electrode 122 may be coupled to the second electrode tab 125, which extends in a second direction (for example, the D2 direction) opposite to the first direction (for example, the D1 direction) and is bent. In some embodiments, the second electrode tab 125 may be vertically bent to be coupled to the cap assembly 140. However, the present disclosure is not limited thereto, and the second electrode tab 125 may be bent into various shapes and can be coupled to the cap assembly 140.

In some embodiments, the first electrode tab 124 of the electrode assembly 120 may be welded to the bottom part 111 of the case 110. Accordingly, the case 110 may operate as the negative electrode. In some embodiments, the second electrode tab 125 may be welded to the bottom part 111 of the case 110, and thus the case 110 may operate as the positive electrode.

A first insulating plate 126, which is coupled with the case 110 and includes a first hole 126a formed in a center thereof and a second hole 126b formed in a periphery thereof, may be disposed between the electrode assembly 120 and the bottom part 111. The first insulating plate 126 may serve to prevent the electrode assembly 120 from being in electrical contact with the bottom part 111 of the case 110. In some embodiments, the first insulating plate 126 may serve to prevent the second electrode 122 of the electrode assembly 120 from being in electrical contact with the bottom part 111. The first hole 126a may serve to allow gas to quickly move upwardly through the center pin 130 in the event a relatively large amount of gas is generated due to a certain abnormality happening in the secondary battery 100, and the second hole 126b may serve to allow the first electrode tab 124 to pass therethrough so that the first electrode tab 124 may be welded to the bottom part 111.

A second insulating plate 127, which is coupled with the case 110 and includes a first hole 127a formed in a center thereof and a plurality of second holes 127b formed in a periphery thereof, may be disposed between the electrode assembly 120 and the cap assembly 140. The second insulating plate 127 may serve to prevent the electrode assembly 120 from being in electrical contact with the cap assembly 140. In some embodiments, the second insulating plate 127 may serve to prevent the first electrode 121 of the electrode assembly 120 from being in electrical contact with the cap assembly 140. The first hole 127a may serve to allow gas to quickly move to the cap assembly 140 in the event a relatively large amount of gas is generated due to a certain abnormality happening in the secondary battery 100, and a second hole 127b may serve to allow the second electrode tab 125 to pass therethrough so that the second electrode tab 125 is welded to cap assembly 140. The remaining second holes 127b may serve to allow the electrolyte to quickly flows into the electrode assembly 120 in an electrolyte injection process.

Diameters of the first holes 126a and 127a of the first and second insulating plates 126 and 127, respectively, may be less than a diameter of the center pin 130 so that the center pin 130 is prevented from being in electrical contact with the bottom part 111 of the case 110 or the cap assembly 140 due to certain external shocks.

The center pin 130 has a hollow cylindrical shape, and may be joined substantially with the center of the electrode assembly 120. In some embodiments, the center pin 130 may include steel, stainless steel, aluminum, an aluminum alloy, or polybutylene terepthalate, but the present disclosure is not limited thereto. The center pin 130 may serve to suppress deformation of the electrode assembly 120 during charging and discharging of the secondary battery 100 and may serve as a moving passage of the gas generated in the inside of the secondary battery 100. In some embodiments, the center pin 130 may be omitted.

The cap assembly 140 may be fixed to an interior side of the crimping part 141 via a gasket 145 to be electrically connected to the electrode assembly and to seal the case 110. The cap assembly 140 may include a top plate 141, a middle plate 142, an insulating plate 143, and a bottom plate 144. However, the cap assembly 140 is not limited thereto.

The middle plate 142 may be positioned below the top plate 141, and may have a substantially flat shape.

The insulating plate 143 may have a circular ring shape having a certain width. The insulating plate 143 may serve to insulate the middle plate 142 and the bottom plate 144 from each other. In some embodiments, the insulating plate 143 may be interposed between the middle plate 142 and the bottom plate 144 and be ultrasonically welded therebetween, but the present disclosure is not limited thereto.

The present disclosure is not limited to a cylindrical type secondary battery 100. As long as the secondary battery 100 includes the electrode assembly 120 formed by winding the second electrode 122, the first electrode 121, and the separator 123 and the case 110 configured to accommodate the corresponding electrode assembly 120, embodiments of the present disclosure is applicable to various types or shapes of secondary batteries.

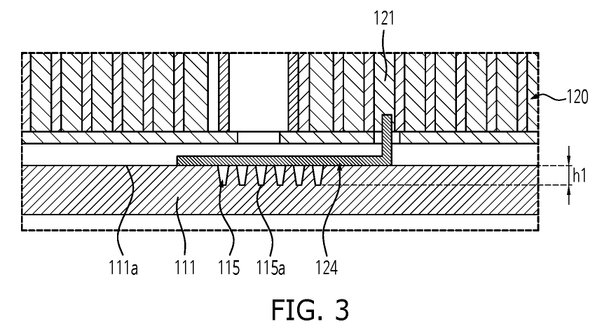

FIG. 3 is an enlarged view showing a portion of the secondary battery in FIG. 2.

The secondary battery may include the first electrode tab 124 coupled to the first electrode 121 of the electrode assembly. From the first electrode 121, the first electrode tab 124 may extend in the first direction (the D1 direction of FIG. 2) relative to the winding axis and is bent perpendicular to the winding axis.

According to some embodiments, the first electrode tab 124 may include a surface parallel with the winding axis and a surface perpendicular to the winding axis. The surface perpendicular to the winding axis may be parallel with the bottom part 111 of the case. In some embodiments, at least a portion of the first electrode tab 124 may be in contact with the bottom part 111. The first electrode tab 124 may have a bent shape not only in a perpendicular manner but in, for example, a curved manner.

According to some embodiments, the first electrode tab 124 may be coupled with the bottom part 111 of the case. In some embodiments, the bottom part 111 and the first electrode tab 124 may be coupled with each other via laser welding. The first electrode tab 124 may be positioned to be in close contact with the bottom part 111. The first electrode tab 124 and the bottom part 111 may be welded into one integrated electrode.

According to some embodiments, to increase a contact area with the bottom part 111, the first electrode tab 124 may have an area of the surface perpendicular to the winding axis larger than an area of the surface parallel with the winding axis. In this manner, heat may be dispersed through the larger area (i.e., the surface perpendicular to the winding axis). Thus damage of the secondary battery can be prevented and enhanced welding strength between the bottom part 111 and the first electrode tab 124 can be achieved.

The bottom part 111 may include a first region with which the first electrode tab 124 is joined and a remaining region other than the first region. According to some embodiments, the first region may include a plurality of grooves 115. In some embodiments, the plurality of grooves 115 may be formed toward the bottom of the case. The plurality of grooves 115 may be formed by cutting or pressing portions of the bottom part 111. The plurality of grooves 115 may have a certain maximum depth h1 from a top surface 111a of the bottom part 111. The maximum depth h1 of the plurality of grooves 115 may be a maximum depth h1 from the the top surface 111a of the bottom part to a bottom surface 115a of any of the plurality of grooves 115. The maximum depth h1 of the plurality of grooves 115 may be equal to or less than 30 % of the thickness of the bottom part 111. In this manner, satisfactory welding strength between the bottom part 111 and the first electrode tab 124 can be achieved. However, the present disclosure is not limited thereto, and the maximum depth h1 of the plurality of grooves 115 may be appropriately changed according to the area and thickness of the bottom part 111 such that the rigidity of the case can be maintained.

Each of the plurality of grooves 115 may be formed to have a certain width. To enhance the welding strength of the plurality of grooves 115, the width of any of the plurality of grooves 115 may be varied. In some embodiments, the widths of the plurality of grooves 115 may be reduced, and accordingly the welding strength between the bottom part 111 and the first electrode tab 124 may be increased.

In some embodiments, the first electrode tab 124 may include a trace due to the welding, coupled with the first region of the bottom part 111. According to some embodiments, the circular or linear welding trace may be formed in a portion of the first electrode tab 124 which is in direct contact with the first region of the bottom part 111. The welding trace may be varied depending on the method of welding. The welding trace may have a dotted shape disposed at a certain interval due to spot welding, and the welding trace may have a line shape arranged parallel with the bottom part 111 due to line welding. To increase the welding strength, a plurality of welding traces may be disposed at a certain interval and/or may be symmetrically disposed.

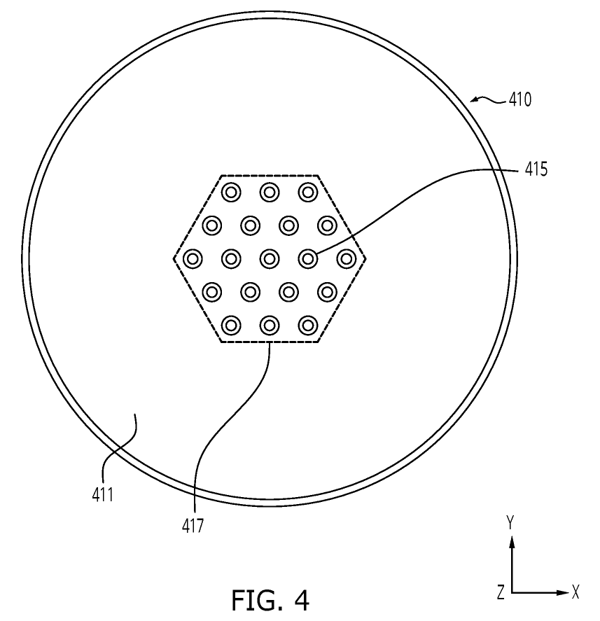

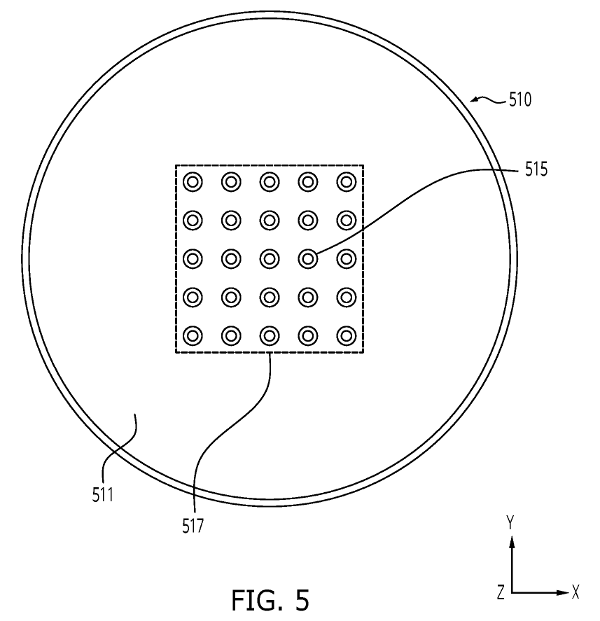

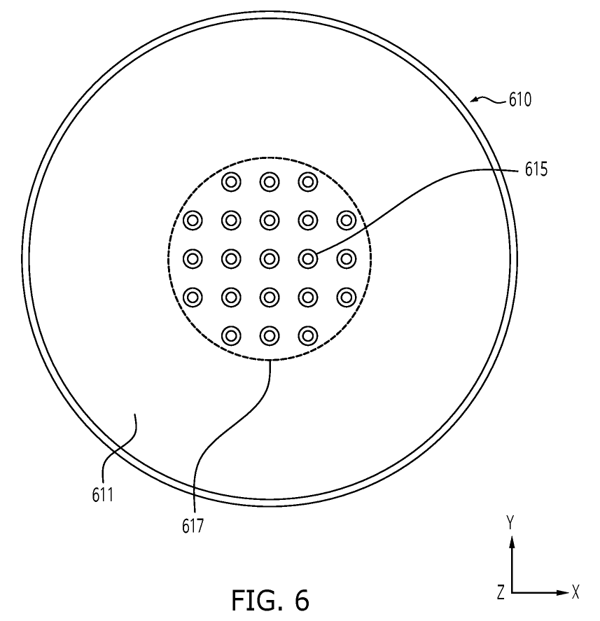

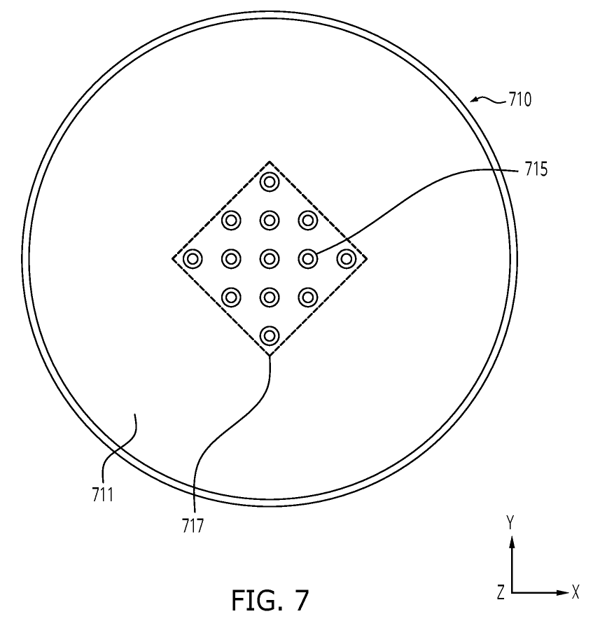

FIG. 4 shows a first region 417 according to embodiments of the present disclosure. FIG. 5 shows a first region 517 according to embodiments of the present disclosure. FIG. 6 shows a first region 617 according to embodiments of the present disclosure. FIG. 7 shows a first region 717 according to embodiments of the present disclosure.

Referring to FIGS. 4 to 7, bottom parts 411, 511, 611, and 711 of cases 410, 510, 610, and 710, respectively, may include the first regions 417, 517, 617, and 717, respectively, coupled with first electrode tabs. The first regions 417, 517, 617, and 717 may include a plurality of grooves 415, 515, 615, and 715, respectively, and shapes of the first regions 417, 517, 617, and 717 may be variously changed according to arrangements of the plurality of grooves 415, 515, 615, and 715, respectively. For example, grooves 415, 515, 615, and 715 among the plurality of grooves 415, 515, 615, and 715, respectively, which are arranged in outer peripheries of the first regions 417, 517, 617, and 717, respectively, may form the shapes of the first regions 417, 517, 617, and 717, respectively. In this manner, satisfactory welding strength between the bottom parts 411, 511, 611, and 711 and the first electrode tabs can be achieved.

According to some embodiments, the first regions 417, 517, 617, and 717 may be formed in centers of the bottom parts 411, 511, 611, and 711, respectively. In some embodiments, the plurality of grooves 415, 515, 615, and 715 may be formed in the centers of the bottom parts 411, 511, 611, and 711, respectively, and the first electrode tabs may be disposed in positions corresponding thereto. However, the present disclosure is not limited thereto, and the first regions 417, 517, 617, and 717 may be formed in other positions of the bottom parts 411, 511, 611, and 711, respectively, to correspond to the first electrode tabs.

According to some embodiments, widths of the first regions 417, 517, 617, and 717 may correspond to widths of the first electrode tabs in a direction perpendicular to the direction of the first electrode tabs extending relative to the winding axis. However, the present disclosure is not limited thereto, and the widths of the first regions 417, 517, 617, and 717 may be less than the widths of the first electrode tabs. In some embodiments, the plurality of grooves 415, 515, 615, and 715 may not be exposed to the exterior direction via the first electrode tabs.

According to some embodiments, the plurality of grooves 415, 515, 615, and 715 may have a circular shape in the winding axis direction. According to some embodiments, the first electrode tabs and the bottom parts 411, 511, 611, and 711 may be spot-welded in positions corresponding to positions of the plurality of grooves 415, 515, 615, and 715, respectively, and a plurality of welding traces may correspond to the positions of the plurality of grooves 415, 515, 615, and 715.

The plurality of grooves 415, 515, 615, and 715 may have a circular shape. However, the present disclosure is not limited thereto. The plurality of grooves 415, 515, 615, and 715 may have shapes optimized to increase surface areas of the bottom parts 411, 511, 611, and 711, respectively. In some embodiments, the plurality of grooves 415, 515, 615, and 715 may have various shapes, for example, a rectangular shape, a U shape, or the like.

The first regions 417, 517, 617, and 717 may have a circular shape, a quadrangular shape, or a hexagonal shape. According to some embodiments, the plurality of grooves 415, 515, 615, and 715, which are spaced apart at certain intervals, may be formed in the first regions 417, 517, 617, and 717, respectively, and each groove of the plurality of grooves 415, 515, 615, and 715, which are arranged in the outer peripheries, may have a circular shape, a quadrangular shape, and hexagonal shape accordingly.

According to some embodiments, the plurality of grooves 415, 515, 615, and 715 may be disposed along perimeters of the first regions 417, 517, 617, and 717, respectively, and may be disposed at certain intervals in the interior of the first regions 417, 517, 617, and 717, respectively. However, the present disclosure is not limited thereto, an optimized number of grooves 415, 515, 615, and 715 may be disposed in optimized shapes to increase the surface areas of the bottom parts 411, 511, 611, and 711, respectively. In some embodiments, the first regions 417, 517, 617, and 717 may be formed in radial patterns, and the intervals between the plurality of grooves 415, 515, 615, and 715, respectively, arranged on the radial patterns may be reduced toward the centers of the first regions 417, 517, 617, and 717, respectively.

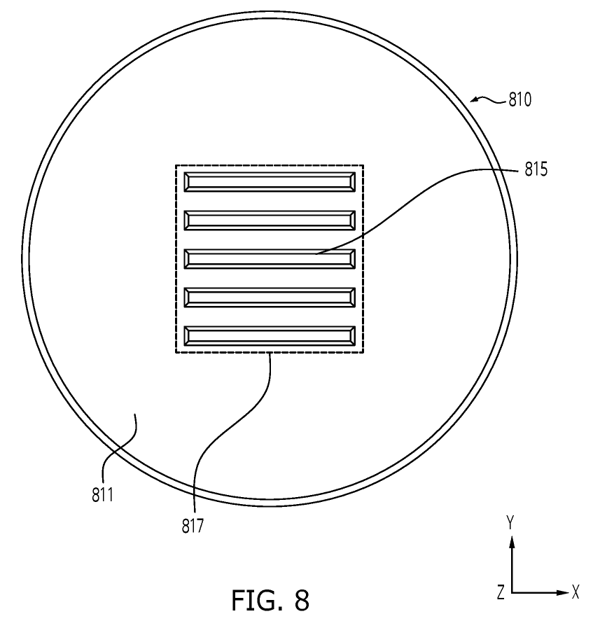

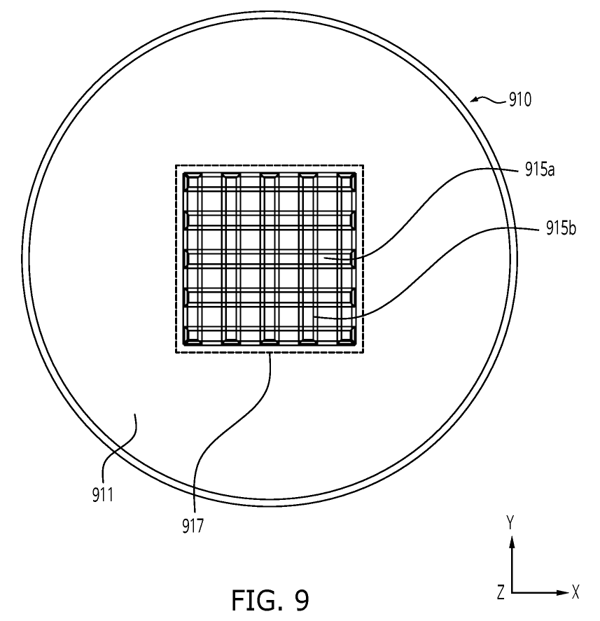

FIG. 8 shows a first region 817 according to embodiments of the present disclosure. FIG. 9 shows a first region 917 according to embodiments of the present disclosure.

Referring to FIG. 8, a plurality of grooves 815 may have a plurality of bar shapes parallel with one another. In some embodiments, the plurality of grooves 815 may be arranged at a certain interval in a first region 817 in one direction (for example, X-axis direction) along a bottom part 811.

Referring to FIG. 9, a plurality of grooves 915 may be disposed in a matrix form in which a plurality of bars are perpendicularly intersected. In some embodiments, in the first region 917, portions 915a of the plurality of grooves 915 may be arranged at a certain interval in one direction (for example, X-axis direction) along a bottom part 911 and remaining portions 915b of the plurality of grooves 915 other than the portions 915a may be arranged in a direction (for example, Y-axis direction) perpendicular to the one direction (for example, X-axis direction).

FIG. 8 shows that the plurality of grooves 815, for example, five grooves 815 are disposed to be spaced apart at a certain interval, and FIG. 9 shows that the portions 915a of the plurality of grooves 915 are disposed to be spaced apart at a certain interval and the remaining portions 915b of the plurality of grooves 915, which are perpendicular to the portions 915a, are disposed to be spaced apart at a certain interval. However, the present disclosure is not limited thereto, and the numbers and intervals of the plurality of grooves 815 and 915 may be appropriately varied such that the rigidity of the bottom parts 811 and 911, respectively, in which the plurality of grooves 815 and 915 are formed, can be maintained.

According to some embodiments, the plurality of grooves 815 and 915 may have a rectangular shape in the winding axis direction. According to some embodiments, first electrode tabs and the bottom parts 811 and 911 may be line-welded in positions corresponding to positions of the plurality of grooves 815 and 915, and a plurality of welding traces may correspond to the positions of the plurality of grooves 815 and 915.

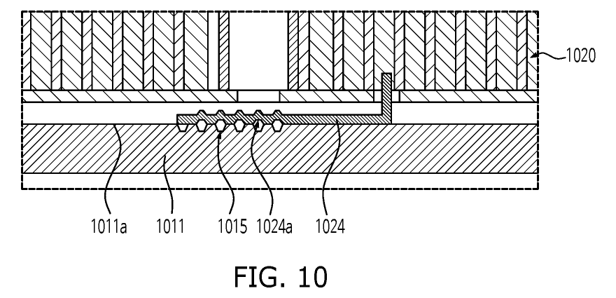

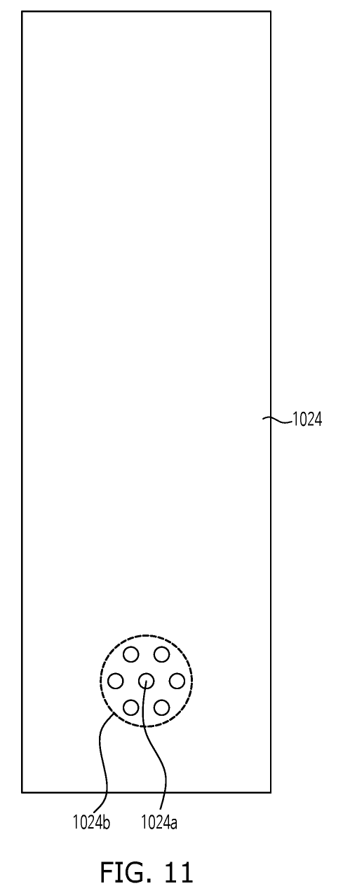

FIG. 10 shows a first electrode tab 1024 according to embodiments of the present disclosure. FIG. 11 shows a second region 1024b according to embodiments of the present disclosure.

Referring to FIGS. 10 and 11, the first electrode tab 1024 may include the second region 1024b which faces and is coupled with a first region of a bottom part 1011.

According to some embodiments, the second region 1024b may include an embossing 1024a which is formed by pressing the first electrode tab 1024. In some embodiments, the embossing 1024a may have a structure in which a plurality of protrusions or patterns are repeatedly formed in a surface of the second region 1024b. The plurality of protrusions constituting the embossing 1024a may be coupled with one surface 1011a of the bottom part 1011. In some embodiments, the plurality of protrusions may be disposed between a plurality of grooves 1015 of the bottom part 1011.

FIG. 10 shows that the protrusions are formed by pressing the first electrode tab 1024 toward an electrode assembly 1020 on the basis of the bottom part 1011, but the present disclosure is not limited thereto. The protrusions may be formed by pressing the first electrode tab 1024 toward the bottom part 1011 from the electrode assembly 1020. In this manner, the plurality of protrusions constituting the embossing 1024a may correspond to the plurality of grooves 1015 so that a contact area between the bottom part 1011 and the first electrode tab 1024 may be maximized.

According to some embodiments, the second region 1024b may be formed in the center of the first electrode tab 1024 in a width direction of the first electrode tab 1024. In some embodiments, the plurality of grooves 1015 may be formed in the bottom part 1011 corresponding to the center of the first electrode tab 1024 in the width direction, and the first region may have a position corresponding thereto. However, the present disclosure is not limited thereto, and the second region 1024b may have a different position of the first electrode tab 1024 to correspond to the first region.

According to some embodiments, a width of the second region 1024b may correspond to a width of the first region. However, the present disclosure is not limited thereto, and the width of the second region 1024b may be greater than the width of the first region. In some embodiments, the insides of the plurality of grooves 1015 may not expose to the outside by the first electrode tab 1024.

According to some embodiments, the first electrode tab 1024 and the bottom part 1011 may be spot-welded in a position corresponding to the position of the embossing 1024a, and a plurality of welding traces may correspond to the positions of the plurality of grooves.

The plurality of protrusions constituting the embossing 1024a may have a circular shape. However, the present disclosure is not limited thereto, and the protrusions may be formed in an optimized shape to increase a surface area of the first electrode tab 1024. In some embodiments, the first electrode tab 1024 may be pressed into various shapes, for example, a rectangular shape, a U-shaped, or the like.

According to some embodiments, a shape of the second region 1024b may correspond to the shape of the first region. The second region 1024b may have a circular shape, a quadrangular shape, or a hexagonal shape. According to some embodiments, the plurality of protrusions which are spaced apart at a certain interval may be formed in the second region 1024b to form a circular-shaped pattern, a quadrangular-shaped pattern, or a hexagonal-shaped pattern. However, the present disclosure is not limited thereto, and an optimized number of protrusions may be disposed in an optimized shape to increase the contact surface area with the bottom part 1011.

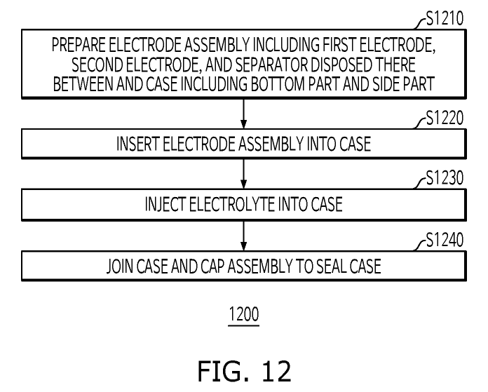

FIG. 12 shows a method 1200 for manufacturing a secondary battery according to embodiments of the present disclosure.

The manufacturing method 1200 of a secondary battery may include preparing an electrode assembly including a first electrode, a second electrode, and a separator disposed therebetween and a case including a bottom part and a side part (S1210). The bottom part may include a first region with which the first electrode tab coupled to the first electrode is joined, and a plurality of grooves may be formed in the first region of the bottom part.

According to some embodiments, the electrode assembly may be formed in such a manner that the first electrode, the second electrode, and the separator are wound relative to a winding axis. The first electrode may be coupled to the first electrode tab which extends in a first direction on the winding axis and is bent, and the second electrode may be coupled to the second electrode tab which extends in a second direction opposite to the first direction and is bent.

Then, the electrode assembly may be inserted into the case (S1220). In some embodiments, the first electrode tab may be weld-coupled with the first region of the bottom part, and the second electrode tab may be weld-coupled with a cap assembly. According to some embodiments, the first electrode tab may include a trace according to the weld-coupling with the first region of the bottom part.

An electrolyte may be injected into the case (S1230). Then, the cap assembly may be coupled with the case to seal the case (S1240).

The flowchart of FIG. 12 and the detailed description therefor are merely examples of the present disclosure, and the scope of the present disclosure is not limited to the flowchart of FIG. 12 and the detailed description therefor. For example, one or more processes in the flowchart and the detailed description therefor may be added/changed/deleted, the order of one or more processes may be changed, and one or more processes may be performed simultaneously.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

### DESCRIPTION OF NOTABLE REFERENCE SYMBOLS

100: secondary battery

110: case

113: beading part

114: crimping part

140: cap assembly

141: top plate

What is claimed is:

1. A secondary battery comprising:
an electrode assembly comprising a first electrode, a second electrode, and a separator positioned between the first electrode and the second electrode;
a case accommodating the electrode assembly, the case comprising a bottom part and a side part;
a cap assembly electrically coupled to the electrode assembly, the cap assembly sealing the case; and
a first electrode tab coupled to the first electrode,
wherein the bottom part comprises a first region,
wherein the first region is coupled with the first electrode tab, and
wherein the first region comprises a plurality of grooves.

2. The secondary battery as claimed in claim 1, wherein the first electrode, the second electrode, and the separator are wound relative to a winding axis,
wherein the first electrode is coupled to the first electrode tab which extends in a first direction relative to the winding axis and is bent,
wherein the secondary battery further comprises a second electrode tab, and
wherein the second electrode is coupled to the second electrode tab which extends in a second direction opposite to the first direction and is bent.

3. The secondary battery as claimed in claim 1, wherein the first electrode tab comprises a weld trace coupling the first electrode and the first region.

4. The secondary battery as claimed in claim 1, wherein the first region is substantially positioned in a center of the bottom part.

5. The secondary battery as claimed in claim 1, wherein the first region has a circular shape, a quadrangular shape, or a hexagonal shape.

6. The secondary battery as claimed in claim 1, wherein each of the plurality of grooves has a circular shape.

7. The secondary battery as claimed in claim 1, wherein the plurality of grooves has a plurality of bar shapes parallel with one another.

8. The secondary battery as claimed in claim 1, wherein the plurality of grooves has a matrix form in which a plurality of bars are perpendicularly intersected.

9. The secondary battery as claimed in claim 1, wherein the first electrode tab comprises a second region facing and being coupled with the first region, and
wherein the second region comprises an embossing in a thickness direction of the first electrode tab.

10. The secondary battery as claimed in claim 9, wherein the second region has a shape corresponding to that of the first region.

11. The secondary battery as claimed in claim 1, wherein the plurality of grooves has a depth equal to or less than 30 % a thickness of the bottom part.

12. A case for a secondary battery comprising an electrode assembly, the electrode assembly comprising a first electrode, a second electrode, and a separator positioned between the first electrode and the second electrode; a cap assembly electrically coupled to the electrode assembly, the cap assembly sealing the case; and a first electrode tab coupled to the first electrode, the case comprising:
a bottom part comprising a first region, the first region being coupled with the first electrode tab; and
a side part,
wherein the first region comprises a plurality of grooves, and
wherein the case accommodates the electrode assembly.

13. The case as claimed in claim 12, wherein the first region has a circular shape, a quadrangular shape, or a hexagonal shape.

14. The case as claimed in claim 12, wherein each of the plurality of grooves has a circular shape.

15. The case as claimed in claim 12, wherein the plurality of grooves has a plurality of bar shapes parallel with one another.

16. The case as claimed in claim 12, wherein the plurality of grooves has a matrix form in which a plurality of bars are perpendicularly intersected.

17. A method for manufacturing a secondary battery comprising:
preparing an electrode assembly comprising a first electrode, a second electrode, and a separator positioned between the first electrode and the second electrode, and a case comprising a bottom part and a side part;
accommodating the electrode assembly into the case;
introducing an electrolyte into the case; and
sealing the case by coupling the case and a cap assembly,
wherein the bottom part comprises a first region,
wherein the first region is coupled with a first electrode tab,
wherein the first electrode tab is coupled to the first electrode, and
wherein the first region comprises a plurality of grooves.

18. The method as claimed in claim 17, wherein the first electrode, the second electrode, and the separator are wound relative to a winding axis,
wherein the first electrode is coupled to the first electrode tab which extends in a first direction relative to the winding axis and is bent, and
wherein the second electrode is coupled to a second electrode tab which extends in a second direction opposite to the first direction and is bent.

19. The method as claimed in claim 18, wherein the accommodating comprises:
welding the first electrode tab and the first region; and
welding the second electrode tab and the cap assembly.

20. The method as claimed in claim 19, wherein the first electrode tab comprises a weld trace.
